(19) United States
(12) Patent Application Publication
(10) Pub. No.: US 2024/0364176 A1
(43) Pub. Date: Oct. 31, 2024

(54) MOTOR DEVICE AND MANUFACTURING METHOD THEREOF

(71) Applicant: MITSUBA Corporation, Gunma (JP)

(72) Inventors: NAOYUKI MIYASHITA, Gunma (JP); SHUHEI KOIKE, Gunma (JP)

(73) Assignee: MITSUBA Corporation, Gunma (JP)

(21) Appl. No.: 18/542,750

(22) Filed: Dec. 17, 2023

(30) Foreign Application Priority Data
Apr. 28, 2023 (JP) 2023-074261

(51) Int. Cl. H02K 5/06; H02K 5/173; H02K 7/08; H02K 11/33; H02K 15/14; H02K 21/16

(52) U.S. Cl. CPC H02K 5/06; H02K 5/1732; H02K 7/083; H02K 11/33; H02K 15/14; H02K 21/16; H02K 2211/03

(57) ABSTRACT

In a motor device, a case includes a total of three first insertion holes through which fixing male screws fixing the case to a bracket are respectively inserted, and a total of three second insertion holes through which fixing bolts fixing the bracket to an electric brake device are respectively inserted. The bracket has a total of three female screw members into which the fixing male screws are respectively screwed, and insertion holes of a total of three collars through which the fixing bolts are respectively inserted. The total of three second insertion holes and the insertion holes of the total of three collars respectively include round holes that are arranged on an axis with each other and position the case with respect to the bracket.

### CROSS-REFERENCE TO RELATED APPLICATION

This application claims the priority benefit of Japan application serial no. 2023-074261, filed on Apr. 28, 2023. The entirety of the above-mentioned patent application is hereby incorporated by reference herein and made a part of this specification.

### BACKGROUND

### Technical Field

The disclosure relates to a motor device having a stator and a rotor rotated with respect to the stator, and a manufacturing method thereof.

### Related Art

For example, Patent Document 1 (Japanese Patent No. 5141681) describes a motor including a stator case in which a stator is fixed, and a flange to which a resolver stator is fixed and which is fixed to an opening of the stator case. The stator case is provided with a long hole, and the flange is provided with a screw hole. The flange is fixed to the opening of the stator case by inserting a screw into the long hole and screwing the screw into the screw hole.

However, in the technique described in Patent Document 1, when screwing the screw into the screw hole, the flange and the stator case are rotated with respect to each other, and position adjustment between the flange and the stator case is performed while confirming the relationship between the resolver signal and the induced voltage. After performing position adjusting between the flange and the stator case, the two are fixed. Thus, it is required to perform position adjustment between the flange and the stator case before fixing the two, which complicates the assembly process of the motor.

### SUMMARY

In an embodiment of the disclosure, a motor device has a stator and a rotor rotated with respect to the stator, and the motor device includes a case, a bracket, a board, and a sensor magnet. The stator is fixed at a specified position inside the case. The bracket closes an opening of the case and is fixed to a driven target. The board is fixed at a specified position of the bracket and includes a magnetic sensor detecting rotation of the rotor. The sensor magnet is rotated together with the rotor and is opposed to the magnetic sensor. The case includes a plurality of first screw holes and a plurality of second screw holes. First male screw members fixing the case to the bracket are respectively inserted through the plurality of first screw holes. Second male screw members fixing the bracket to the driven target are respectively inserted through the plurality of second screw holes. The bracket includes a plurality of female screw members and a plurality of insertion holes. The first male screw members are respectively screwed into the plurality of female screw members. The second male screw members are respectively inserted through the plurality of insertion holes. The plurality of second screw holes and the plurality of insertion holes respectively include round holes that are arranged coaxially with each other and position the case with respect to the bracket.

In another embodiment of the disclosure, a manufacturing method of a motor device is a manufacturing method of a motor device having a stator and a rotor rotated with respect to the stator. The motor device includes a case, a bracket, a board, and a sensor magnet. The stator is fixed at a specified position inside the case. The bracket closes an opening of the case and is fixed to a driven target. The board is fixed at a specified position of the bracket and includes a magnetic sensor detecting rotation of the rotor. The sensor magnet is rotated together with the rotor and is opposed to the magnetic sensor. The manufacturing method includes processes below. In a butting process, the opening of the case is butted against the bracket, and a case-side round hole provided at the case and a bracket-side round hole provided at the bracket are caused to communicate with each other in an axial direction of the rotor. In a positioning process, a positioning jig is inserted into the case-side round hole and the bracket-side round hole, and the case-side round hole and the bracket-side round hole are arranged coaxially with each other to position the case with respect to the bracket. In a screw fastening process, with the case positioned with respect to the bracket, a fixing male screw is inserted through a long hole provided at the case, and the fixing male screw is screwed into a fixing female screw provided at the bracket.

According to the disclosure, it is possible to realize a motor device and a manufacturing method thereof having a structure capable of simplifying the assembly process and reducing variations in motor characteristics.

### BRIEF DESCRIPTION OF DRAWINGS

FIG. 1 shows a perspective view of a motor device as viewed from a bracket side.

FIG. 2 shows a perspective view of the motor device as viewed from a case side.

FIG. 3 shows a cross-sectional view illustrating an internal structure of the motor device.

FIG. 4 shows a view of an inner side of the case as viewed from an axial direction of a rotating shaft.

FIG. 5 shows a perspective view of a stator and a busbar unit.

FIG. 6 shows a view of a sensor board side of the bracket as viewed from the axial direction of the rotating shaft.

FIG. 7 shows an exploded perspective view illustrating an assembly procedure of the motor device.

FIG. 8 shows a view illustrating positioning parts at two spots of the motor device.

### DESCRIPTION OF EMBODIMENTS

Embodiments of the disclosure provide a motor device and a manufacturing method thereof having a structure capable of simplifying the assembly process and reducing variations in motor characteristics.

Hereinafter, an embodiment of the disclosure will be described in detail with reference to the drawings.

### <Motor Device>

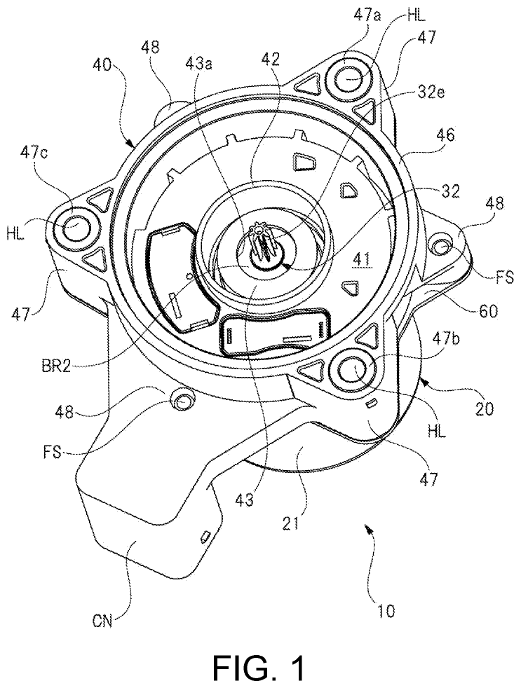

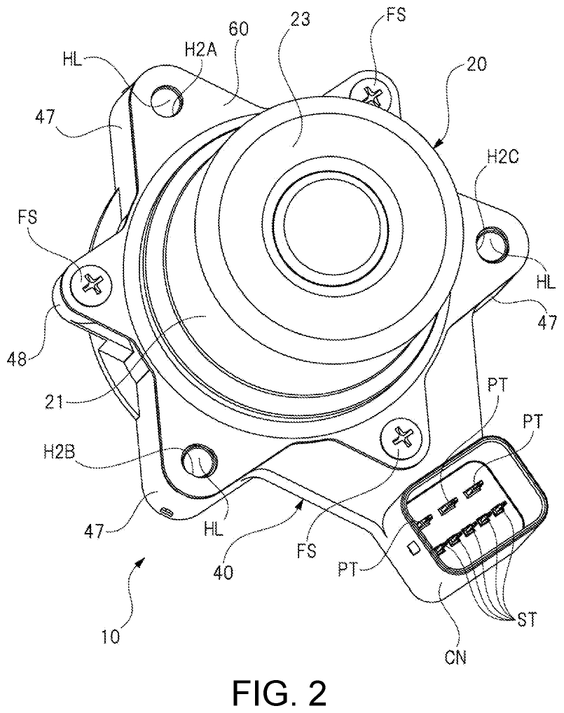

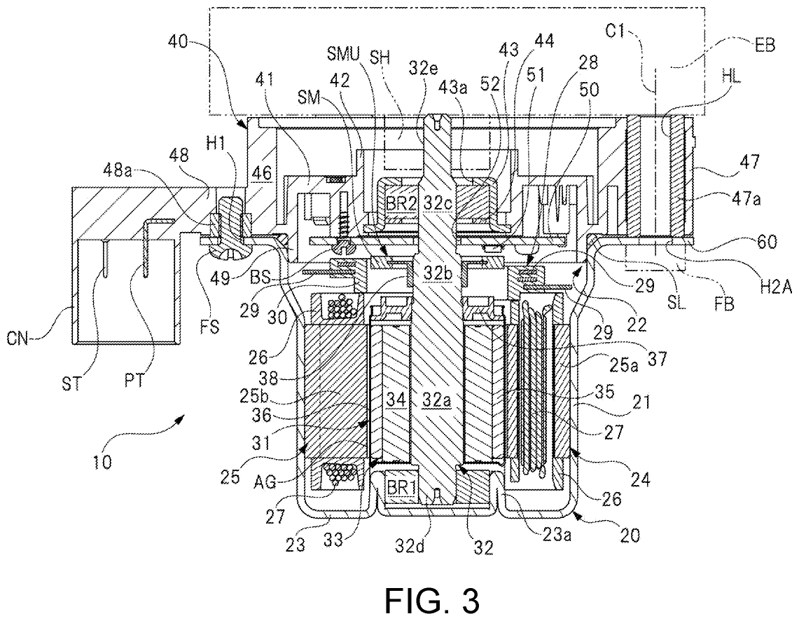

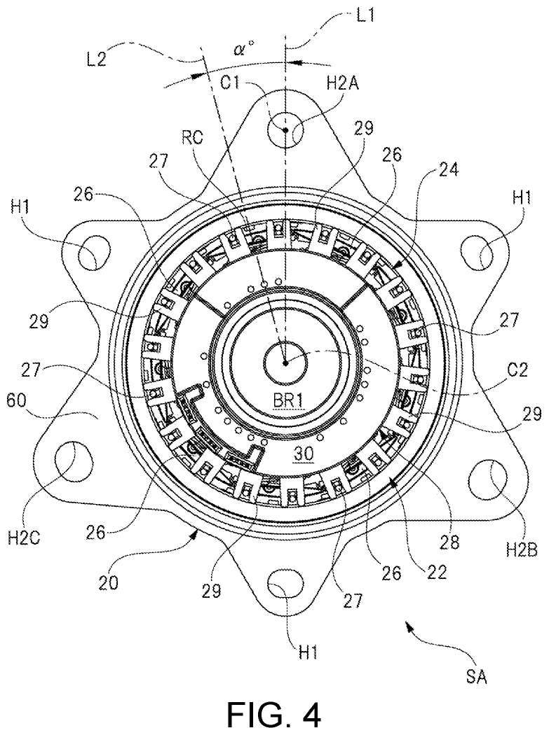

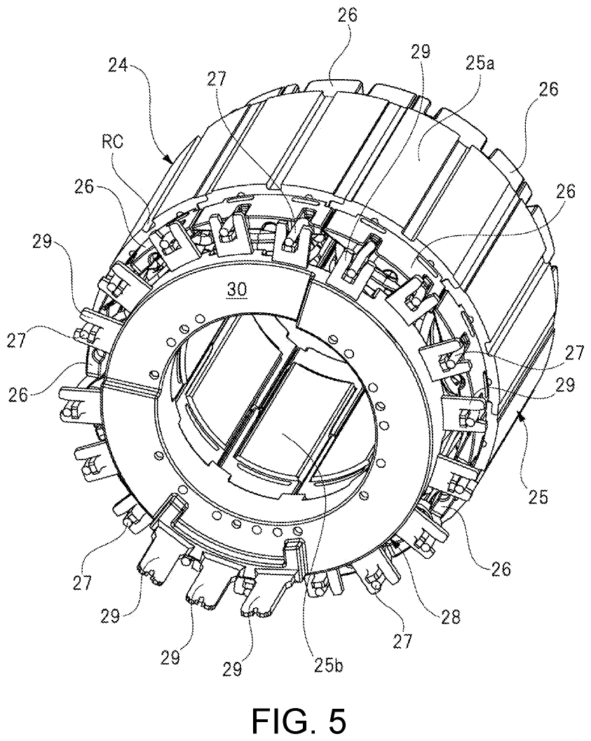

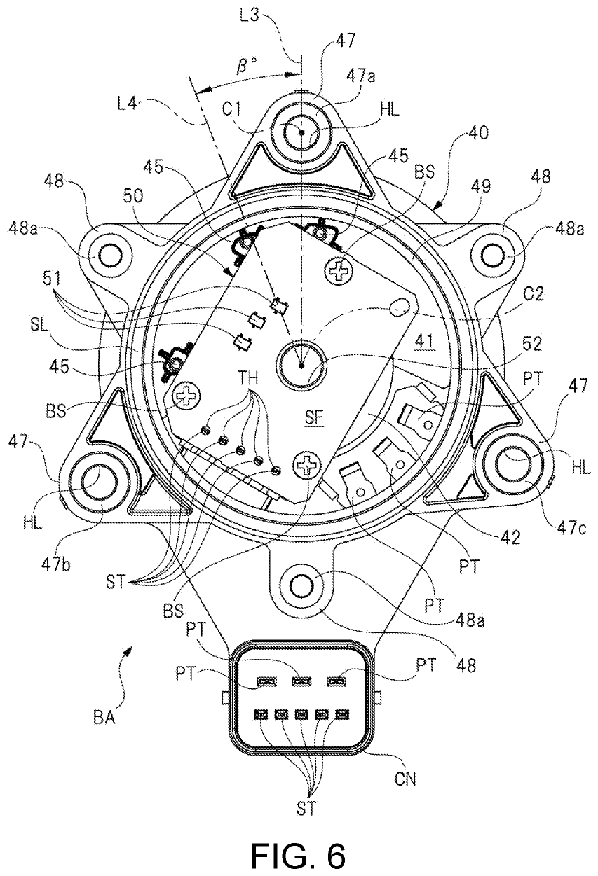

FIG. 1 shows a perspective view of a motor device as viewed from a bracket side. FIG. 2 shows a perspective view of the motor device as viewed from a case side. FIG. 3 shows a cross-sectional view illustrating an internal structure of the motor device. FIG. 4 shows a view of an inner side of the case as viewed from an axial direction of a rotating shaft. FIG. 5 shows a perspective view of a stator and a busbar unit. FIG. 6 shows a view of a sensor board side of the bracket as viewed from the axial direction of the rotating shaft.

A motor device 10 shown in FIG. 1 to FIG. 3 is used as, for example, a driving source of an electric brake device EB (see FIG. 3) mounted to a vehicle such as an automobile. In FIG. 3, the electric brake device EB is shown by double-dot dashed lines (virtual lines) and is simplified. Herein, the electric brake device EB corresponds to a “driven target” in the disclosure.

The motor device 10 is a brushless motor and includes a case 20 made of metal. The case 20 is formed into a bottomed tubular shape by performing deep drawing or the like on a metal plate. The case 20 includes a cylindrical part 21. An opening 22 is provided on one axial side (upper side in FIG. 3) of the cylindrical part 21, and a bottom wall part 23 is provided on another axial side (lower side in FIG. 3) of the cylindrical part 21.

Then, the opening 22 of the case 20 is closed by a bracket 40 for fixing the motor device 10 to the electric brake device EB. On the other hand, a bearing mounting tubular part 23a to which a first bearing BR1 is mounted is provided at a central part on the inner side of the bottom wall part 23 of the case 20. The bearing mounting tubular part 23a is formed into a cylindrical shape by folding back and standing up a metal plate when forming the case 20. The first bearing BR1 mounted to the case 20 rotatably supports a bearing support part 32d of a rotating shaft 32.

### <Stator>

As shown in FIG. 3 and FIG. 4, a stator 24 is accommodated in the case 20. Specifically, the stator 24 is fixed by press-fitting or the like to the radially inner side of the cylindrical part 21 of the case 20.

As shown in FIG. 3 and FIG. 5, the stator 24 includes a stator core 25 formed into a substantially tubular shape, and the stator core 25 is formed by laminating a plurality of thin steel plates (ferromagnetic material). The stator core 25 includes a core main body 25a in an annular shape, and a plurality of teeth 25b provided at the core main body 25a and protruding to the radially inner side.

Furthermore, the stator 24 has an insulator 26 made of resin mounted to each of the plurality of teeth 25b. Then, coils 27 composed of the U-phase, the V-phase, and the W-phase are wound around each insulator 26 with a predetermined number of windings. In other words, the three-phase coils 27 are respectively wound around each of the teeth 25b via the insulator 26, which is an insulating body.

The three-phase coils 27 are arranged alternately in a sequence of U-phase, V-phase, W-phase, U-phase, V-phase, W-phase, etc. in the circumferential direction of the stator 24. Thus, the stator 24 includes the three-phase coils 27.

### <Busbar Unit>

Furthermore, as shown in FIG. 3 to FIG. 5, a busbar unit 28 in an annular shape is provided on one side (upper side in FIG. 3) of the stator 24 in the axial direction of the rotor 31. The busbar unit 28 includes a plurality of conductive members 29 that electrically connect same phases of the three-phase coils 27. The conductive members 29 are held by a holding member 30 in an annular shape. The holding member 30 is composed of an insulating body such as plastic, and prevents each of the conductive members 29 from short-circuiting.

One-end sides of the plurality of conductive members 29 protrude in a radial pattern to the radially outer side from an outer circumferential part of the annular holding member 30. Then, the ends of the three-phase coils 27 are electrically connected by spot welding or the like to portions on the one-end sides of the conductive members 29 that protrude from the holding member 30. On the other hand, another-end sides of the plurality of conductive members 29 are respectively bundled into the three phases (i.e., the U-phase, the V-phase, and the W-phase) to be electrically connected to one-end parts of three power terminals PT (see FIG. 6) provided at the bracket 40.

Herein, the three power terminals PT correspond to the U-phase, the V-phase, and the W-phase, and another-end parts of the power terminals PT are exposed on the inner side of a connector connection part CN (see FIG. 2, FIG. 3, and FIG. 6) to which a vehicle-side connector member (not shown) is connected.

### <Rotor>

As shown in FIG. 3, the motor device 10 includes a rotor 31 that is rotated with respect to the stator 24. The rotor 31 has a rotating shaft 32 and a rotor main body 33. The rotating shaft 32 is formed into a stepped rod shape by cutting a round rod or the like. Specifically, the rotating shaft 32 includes a large-diameter part 32a, a medium-diameter part 32b that is smaller in diameter than the large-diameter part 32a, and a small-diameter part 32c that is smaller in diameter than the medium-diameter part 32b. The rotating shaft 32 is arranged to pass through a through-hole 52 provided at a sensor board 50 and cross the bracket 40 in the axial direction of the bracket 40.

A rotor core 34 forming the rotor main body 33 is fixed by press-fitting or the like to the outer circumferential part of the large-diameter part 32a. That is, the rotating shaft 32 is fixed at the rotation center of the rotor 31 and is rotated along with the rotation of the rotor core 34. A bearing support part 32d is provided on the another axial side (lower side in FIG. 3) of the large-diameter part 32a, and the bearing support part 32d is rotatably supported by the first bearing BR1.

Furthermore, a sensor magnet unit SMU is fixed to the outer circumferential part of the medium-diameter part 32b. The sensor magnet unit SMU includes a holder member 38 and a sensor magnet SM. The holder member 38 is fixed by press-fitting to the medium-diameter part 32b of the rotating shaft 32, and holds the annular sensor magnet SM. The sensor magnet SM serves to detect rotation of the rotor 31 (rotating shaft 32) and is rotated together with the rotor 31.

In addition, the small-diameter part 32c is rotatably supported by a second bearing BR2. In this manner, two axial sides of the rotating shaft 32 are rotatably supported by the first bearing BR1 and the second bearing BR2. Both the first bearing BR1 and the second bearing BR2 are ball bearings (not shown in detail).

Furthermore, a pinion gear part 32e forming an output part of the motor device 10 is integrally provided on the one axial side (upper side in FIG. 3) of the small-diameter part 32c. Specifically, as shown in FIG. 3, the pinion gear part 32e is connected in a manner capable of transmitting power with respect to a feed screw shaft SH, which advances and retracts a piston (not shown) of the electric brake device EB.

Furthermore, the rotor main body 33, which is fixed to the outer circumferential part of the large-diameter part 32a, includes a rotor core 34 that is formed into a substantially tubular shape by laminating a plurality of thin steel plates (ferromagnetic body), and a magnet 35 in a tubular shape that is mounted on the radially outer side of the rotor core 34. The radially outer side of the magnet 35 is covered by a magnet cover 36 in a tubular shape composed of a stainless steel plate or the like.

The magnet cover 36 is fixed to the outer circumferential part of the magnet 35 by crimping the one axial side (upper side in FIG. 3) of the magnet cover 36 to the radially inner side. Accordingly, the rotation center of the magnet 35 and the rotation center of the rotor core 34 are aligned with high precision to suppress rotation unevenness of the rotor 31. Further, it is possible to narrow an air gap AG between the rotor main body 33 and the stator 24 and to realize a motor device 10 in a small size with high output (high efficiency).

To suppress transmission of the crimping force of the magnet cover 36 to the magnet 35, a magnet protection member 37 composed of a resin material such as plastic is provided on the one axial side of the magnet cover 36.

In this manner, the motor device 10 is of a surface permanent magnet type (SPM type) in which the magnet 35 is mounted on the surface of the rotor core 34. However, the motor device 10 is not limited to the SPM type as described above, but may also be of an interior permanent magnet type (IPM type) in which the magnet is embedded inside the rotor core.

### <Bracket>

As shown in FIG. 3, the bracket 40 has a function of fixing the motor device 10 to the electric brake device EB. That is, the bracket 40 is fixed to the electric brake device EB. As shown in FIG. 3 and FIG. 6, the bracket 40 is formed into a substantially circular plate shape by injection molding a resin material such as molten plastic.

The bracket 40 includes a partition wall part 41 formed into a substantially circular plate shape. The partition wall part 41 partitions the bracket 40 into a case 20 side (lower side in FIG. 3) and an electric brake device EB side (upper side in FIG. 3), and an insertion tubular part 42 through which the one axial side (upper side in FIG. 3) of the rotating shaft 32 is inserted is integrally provided at a central part of the partition wall part 41.

Furthermore, a bearing holder 43 formed into a substantially cup shape by press-forming a steel plate or the like is provided on the radially inner side of the insertion tubular part 42. Specifically, the radially outer side of the bearing holder 43 is fixed to the radially inner side of the insertion tubular part 42.

Furthermore, an insertion hole 43a through which the rotating shaft 32 is inserted is provided at the bearing holder 43, and the bearing holder 43 holds the second bearing BR2 to be coaxial with the insertion tubular part 42. That is, the second bearing BR2 is mounted to the bracket 40 via the bearing holder 43. In addition, an annular fixing plate 44 that prevents the second bearing BR2 from falling off the bearing holder 43 is provided on the another axial side (lower side in FIG. 3) of the second bearing BR2.

Furthermore, a sensor board 50 is provided on the another axial side (lower side in FIG. 3) of the insertion tubular part 42. Specifically, the sensor board 50 is fixed to the case 20 side of the partition wall part 41 by a total of three board fixing screws BS (see FIG. 6). Herein, the sensor board 50 is in contact with and supported by a total of three positioning protrusions 45. Accordingly, the sensor board 50 is positioned with high precision by three-point support with respect to the bracket 40.

In this manner, the second bearing BR2 supporting the rotating shaft 32 is mounted to the bracket 40, and the sensor board 50 is positioned with high precision. Thus, Hall elements 51 of the sensor board 50 and the sensor magnet SM of the rotating shaft 32 are opposed to each other with high precision in the axial direction of the rotor 31.

### <Sensor Board>

The sensor board 50 is arranged between the second bearing BR2 and the sensor magnet SM on the case 20 side (lower side in FIG. 3) of the bracket 40. As shown in FIG. 6, a total of three Hall elements 51 are provided on a mounting surface SF of the sensor board 50. Specifically, the Hall elements 51 are arranged around the through-hole 52 arranged substantially at the center of the sensor board 50.

Herein, the total of three Hall elements 51 are opposed to the sensor magnet SM in the axial direction of the rotor 31. Each of the Hall elements 51 detects changes in the magnetic poles of the sensor magnet SM accompanying the rotation of the rotating shaft 32. In other words, the Hall elements 51 detect the rotation of the rotor 31 via the sensor magnet SM.

The sensor board 50 corresponds to a “board” in the disclosure, and the Hall element 51 corresponds to a “magnetic sensor” in the disclosure.

Furthermore, the sensor board 50 is provided with a total of five through-holes TH to which one-end parts of a total of five sensor terminals ST are respectively electrically connected. Another-end parts of the total of five sensor terminals ST are exposed on the inner side of the connector connection part CN, to which a vehicle-side connector member (not shown) is connected (see FIG. 2, FIG. 3, and FIG. 6).

### <Tubular Wall Part>

As shown in FIG. 1 and FIG. 3, a tubular wall part 46 having a diameter larger than the insertion tubular part 42 is provided on the radially outer side of the insertion tubular part 42. Specifically, the tubular wall part 46 is integrally provided on the radially outer side of the partition wall part 41.

The tubular wall part 46 is coaxial with the insertion tubular part 42 and extends in the axial direction of the rotating shaft 32. Further, a total of three driven target fixing parts 47 protruding on the radially outer side of the tubular wall part 46 are integrally provided at the tubular wall part 46. Collars 47a, 47b, and 47c in a cylindrical shape made of metal are respectively attached to the driven target fixing parts 47. Further, a flange part 60 (see FIG. 4) of the case 20 is opposed to the driven target fixing parts 47 in the axial direction of the rotor 31.

In this manner, by providing the collars 47a, 47b, and 47c at the driven target fixing parts 47, the motor device 10 can be firmly fixed to the electric brake device EB without damaging the driven target fixing parts 47 made of resin.

Herein, a total of three (a plurality of) fixing bolts FB (see the double-dot dashed line in FIG. 3) for fixing the motor device 10 to the electric brake device EB are respectively inserted through the collars 47a, 47b, and 47c, and insertion holes HL, which are round holes, are respectively provided at the collars 47a, 47b, and 47c. The fixing bolt FB corresponds to a “second male screw member” in the disclosure.

Furthermore, a connector connection part CN is integrally provided on the radially outer side of the tubular wall part 46. The connector connection part CN is formed in a substantially rectangular box shape, and a vehicle-side connector member (not shown) may be connected from the another axial side (lower side in FIG. 3) of the tubular wall part 46.

Further, a total of three case fixing parts 48 protruding on the radially outer side of the tubular wall part 46 are integrally provided at the tubular wall part 46. The case fixing parts 48 are portions to which the case 20 is fixed, and the flange part 60 (see FIG. 4) of the case 20 is opposed to the case fixing parts 48 in the axial direction of the rotor 31.

Furthermore, female screw members 48a in a tubular shape made of steel are attached to the respective case fixing parts 48. Fixing male screws FS for fixing the case 20 to the bracket 40 are respectively screwed into the female screw members 48a provided at the case fixing parts 48. Herein, the fixing male screw FS screwed into the female screw member 48a corresponds to a “first male screw member” in the disclosure.

As shown in FIG. 6, the three driven target fixing parts 47 and the three case fixing parts 48 are arranged alternately in the circumferential direction of the tubular wall part 46 (bracket 40) with the rotor 31 (see FIG. 3) as the center.

### <Fitting Tubular Part>

Furthermore, a fitting tubular part 49 is integrally provided between the insertion tubular part 42 and the tubular wall part 46 in the radial direction of the bracket 40 on the another axial side (case 20 side) of the bracket 40.

The fitting tubular part 49 is a portion fitted into the opening 22 of the case 20, and an annular seal SL composed of an elastic material such as rubber is mounted on the radially outer side of the fitting tubular part 49. The annular seal SL seals between the bracket 40 and the case 20.

### <Connection Structure Between Case and Bracket>

As shown in FIG. 2 and FIG. 6, the flange part 60 provided at the case 20 is opposed, in the axial direction of the rotor 31 (see FIG. 3), to the three driven target fixing parts 47 and the three case fixing parts 48 provided at the bracket 40.

Specifically, as shown in FIG. 3 and FIG. 4, the flange part 60 protruding to the radially outer side is integrally provided on the one axial side of the cylindrical part 21, that is, on the opening 22 side, of the case 20. The flange part 60 is fixed on the another axial side (lower side in FIG. 3) of the bracket 40 by a total of three (a plurality of) fixing male screws FS. In other words, the fixing male screws FS serve to fix the case 20 to the bracket 40. The fixing male screws FS are tightened by a screwdriver (not shown) with a Phillips head (+) on the tip side.

A total of three (a plurality of) first insertion holes H1 through which the total of three fixing male screws FS are respectively inserted are provided at the flange part 60. The first insertion hole H1 penetrates in the axial direction of the rotor 31 and corresponds to a “first screw hole” in the disclosure.

Then, each of the first insertion holes H1 is a long hole of the same size and the same shape. Specifically, each of the first insertion holes H1 has a substantially oval shape extending slightly in the circumferential direction of the case 20. Thus, the fixing male screw FS is movable in the first insertion hole H1 in a state in which the fixing male screw FS is not fully tightened (loosened state). In other words, by configuring the first insertion hole H1 as a long hole, it is possible to absorb dimensional errors of parts (e.g., the case 20 and the bracket 40) that form the connection portion of the motor device 10.

Further, a total of three (a plurality of) second insertion holes H2A, H2B, and H2C, through which the fixing bolts FB (see FIG. 3) for fixing the bracket 40 (motor device 10) to the electric brake device EB are respectively inserted, are provided at the flange part 60. The second insertion holes H2A, H2B, and H2C penetrate in the axial direction of the rotor 31 and correspond to “second screw holes” in the disclosure.

Further, the second insertion hole H2A (i.e., one of the total of three second insertion holes H2A, H2B, and H2C) is a round hole similar to the insertion hole HL of the collar 47a arranged corresponding to the second insertion hole H2A. The second insertion hole H2A and the insertion hole HL of the collar 47a are arranged coaxially with each other in an assembled state of the motor device 10. Specifically, as shown in FIG. 3, the second insertion hole H2A and the insertion hole HL of the collar 47a are arranged on an axis C1.

In contrast, among the total of three second insertion holes H2A, H2B, and H2C, the other second insertion holes H2B and H2C excluding the second insertion hole H2A, which is a round hole, are long holes in which the fixing bolts FB are movable. The second insertion holes H2B and H2C have the same size and the same shape, and specifically, have a substantially oval shape extending slightly in the circumferential direction of the case 20.

Similarly, with this configuration, it is possible to absorb dimensional errors of the parts (e.g., the case 20 and the bracket 40) that form the motor device 10. Thus, when attaching the motor device 10 (bracket 40) to the electric brake device EB, the fixing bolts FB may be respectively easily inserted into the second insertion holes H2B and H2C and the insertion holes HL of the corresponding collars 47b and 47c.

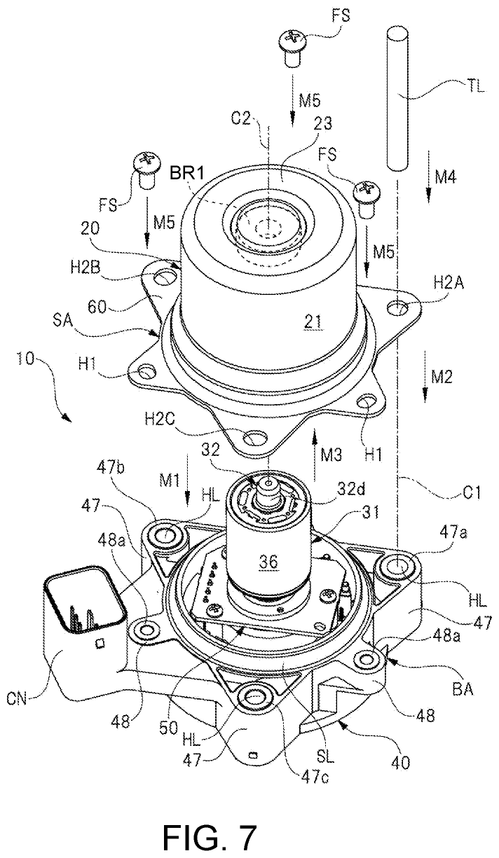

In addition, during assembly of the motor device 10, a positioning jig TL (see FIG. 7) composed of a round bar is inserted into the second insertion hole H2A and the insertion hole HL of the corresponding collar 47a. Accordingly, the second insertion hole H2A and the insertion hole HL of the collar 47a are arranged coaxially.

Herein, instead of a positioning jig TL composed of a round bar, it is also possible to arrange the second insertion hole H2A and the insertion hole HL of the collar 47a coaxially using, for example, the fixing bolt FB. In other words, as long as the second insertion hole H2A and the insertion hole HL of the collar 47a can be arranged coaxially, other members may also be used.

In this manner, the second insertion hole H2A and the insertion hole HL of the corresponding collar 47a have a function of positioning the case 20 with respect to the bracket 40. Thus, it is possible to position the case 20 at the specified position of the bracket 40 with high precision. In other words, the total of three second insertion holes H2A, H2B, and H2C and the total of three insertion holes HL of the collars 47a, 47b, and 47c respectively include round holes that are arranged coaxially (on the axis C1) with each other and position the case 20 with respect to the bracket 40.

Herein, the outer diameter of the positioning jig TL is slightly smaller than the inner diameter of the second insertion hole H2A and the inner diameter of the insertion hole HL of the corresponding collar 47a. Accordingly, the positioning jig TL is easily inserted into the second insertion hole H2A and the insertion hole HL of the corresponding collar 47a. Further, the positioning jig TL is prevented from wobbling in the second insertion hole H2A and in the insertion hole HL of the corresponding collar 47a.

Thus, among the first insertion holes H1 and the second insertion holes H2A, H2B, and H2C (six in total) provided at the flange part 60, only one insertion hole, i.e., the second insertion hole H2A, is a “round hole”, and the other insertion holes, i.e., the first insertion holes H1 and the second insertion holes H2B and H2C (five in total) are “long holes”. In other words, the total of three first insertion holes H1 and the total of three second insertion holes H2A, H2B and H2C respectively include long holes in which the fixing male screws FS and the fixing bolts FB are movable.

As shown in FIG. 4, the first insertion holes H1 and the second insertion holes H2A, H2B, and H2C are arranged alternately in the circumferential direction of the case 20 with the rotor 31 (see FIG. 3) as the center, in a manner similar to the driven target fixing parts 47 and the case fixing parts 48 (see FIG. 6) provided at the bracket 40.

### <Regarding Assembly Procedure>

Next, a manufacturing method of the motor device 10 formed as described above, particularly, an assembly procedure of a stator assembly SA (see FIG. 4) and a bracket assembly BA (see FIG. 6), will be described in detail with reference to the drawings.

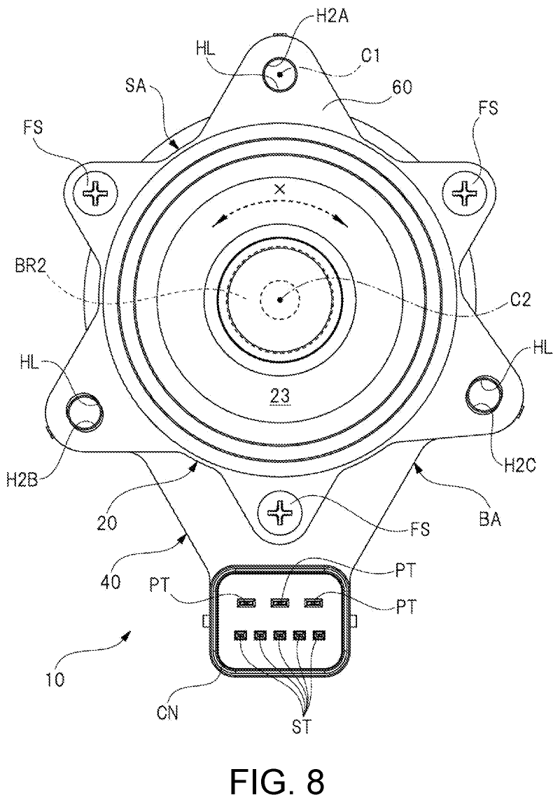

FIG. 7 shows an exploded perspective view illustrating an assembly procedure of the motor device. FIG. 8 shows a view illustrating positioning parts at two spots of the motor device.

<Preparation of stator assembly and bracket assembly>

First, the stator assembly SA (see FIG. 4) and the bracket assembly BA (see FIG. 6), which have been assembled according to separate manufacturing processes, are respectively prepared.

In the stator assembly SA, the stator 24 is positioned and fixed with high precision at a specified position inside the case 20 by an automatic assembly device or the like without variation among products.

Specifically, as shown in FIG. 4, the stator 24 is fixed at a specified position inside the case 20 such that a line segment L1 connecting an axis C2 of the case 20 and the axis C1 of the second insertion hole H2A, and a line segment L2 connecting the axis C2 of the case 20 and a central part (see FIG. 4 and FIG. 5) of a predetermined recess RC provided at the outer circumferential part of the stator core 25, form a specified angle α° with each other.

Similarly, in the bracket assembly BA, the sensor board 50 is positioned and fixed with high precision at a specified position of the bracket 40 by an automatic assembly device or the like without variation among products.

Specifically, as shown in FIG. 6, the sensor board 50 is fixed at a specified position of the bracket 40 such that a line segment L3 connecting the axis C2 of the bracket 40 and the axis C1 of the insertion hole HL of the collar 47a, and a line segment LA connecting the axis C2 of the bracket 40 and a central part of a predetermined Hall element 51 of the sensor board 50, form a specified angle β° with each other.

Accordingly, it becomes possible to arrange the position of the Hall element 51 with respect to the circumferential direction of the stator 24 with high position according to the design by simply assembling the stator assembly SA and the bracket assembly BA to each other with the axis C1 and the axis C2 (see FIG. 4) of the stator assembly SA and the axis C1 and the axis C2 (see FIG. 6) of the bracket assembly BA respectively arranged coaxially.

In other words, by assembling the stator assembly SA and the bracket assembly BA as described below, it becomes possible to realize a motor device 10 in which variations in motor characteristics resulting from a “shift” in sensor signals are suppressed.

### <Rotor Assembly Process>

As indicated by an arrow M1 in FIG. 7, the rotor 31 is mounted to the bracket assembly BA. Specifically, the small-diameter part 32c (see FIG. 3) of the rotating shaft 32 forming the rotor 31 is inserted and supported, from the sensor board 50 side of the bracket 40, into the second bearing BR2 (see FIG. 3) mounted to the bracket 40.

Accordingly, the rotor 31 is assembled to the bracket assembly BA, and the <rotor assembly process> is completed.

### <Butting Process>

Next, as indicated by an arrow M2 in FIG. 7, the stator assembly SA is caused to face the bracket assembly BA. At this time, the opening 22 (see FIG. 3 and FIG. 4) of the case 20 is caused to butt against the sensor board 50 side of the bracket 40.

Then, as indicated by an arrow M3 in FIG. 7, the rotor 31 is inserted into the radially inner side of the stator 24 (see FIG. 3 and FIG. 4) fixed inside the case 20, and the bearing support part 32d of the rotating shaft 32 is inserted into the first bearing BR1 mounted to the bearing mounting tubular part 23a (see FIG. 3) of the case 20. Accordingly, the axis of the case 20 and the axis of the bracket 40 are arranged on the axis C2 (coaxially) with each other.

Subsequently, the second insertion hole (case-side round hole) H2A provided at the case 20 and the insertion hole (bracket-side round hole) HL of the collar 47a provided at the bracket 40 are caused to communicate with each other in the axial direction of the rotor 31.

Accordingly, the stator assembly SA is butted against the bracket assembly BA, and the <butting process> is completed.

### <Positioning Process>

Subsequently, as indicated by an arrow M4 in FIG. 7, the positioning jig TL composed of a round bar is inserted into the second insertion hole H2A and the insertion hole HL of the collar 47a. Accordingly, axial misalignment is eliminated between the second insertion hole H2A and the insertion hole HL of the collar 47a, and the second insertion hole H2A and the insertion hole HL of the collar 47a are arranged on the axis C1 (coaxially) with each other.

Accordingly, the case 20 of the stator assembly SA is positioned at the specified position with respect to the bracket 40 of the bracket assembly BA, and the <positioning process> is completed. In preparation for a next <screw fastening process>, the positioning jig TL is left inserted in the second insertion hole H2A and the insertion hole HL of the collar 47a.

### <Screw Fastening Process>

Next, with the positioning jig TL inserted in the second insertion hole H2A and the insertion hole HL of the collar 47a, that is, with the case 20 positioned with respect to the bracket 40, the stator assembly SA is screw-fastened to the bracket assembly BA.

Specifically, as indicated by an arrow M5 in FIG. 7, a total of three fixing male screws FS are inserted into a total of three first insertion holes (long holes) H1 provided at the flange part 60 of the case 20, and are screwed into the female screw members (fixing female screws) 48a provided at the case fixing parts 48 of the bracket 40 using a screwdriver (not shown). At this time, since the fixing male screws FS are movable in the first insertion holes H1, which are long holes, dimensional errors that are present in the case 20, the bracket 40, etc. are absorbed.

Accordingly, the stator assembly SA and the bracket assembly BA are assembled to each other, the <screw fastening process> is completed, and the motor device 10 is completed.

In addition, during the screwing operation of the fixing male screws FS, as shown in FIG. 8, the axis C1 and the axis C2 (see FIG. 4) of the stator assembly SA and the axis C1 and the axis C2 (see FIG. 6) of the bracket assembly BA are respectively arranged coaxially (on the axis C1 and on the axis C2). Thus, the stator assembly SA and the bracket assembly BA do not rotate and deviate with respect to each other as indicated by a broken line arrow X in FIG. 8 with the axis C2 as the center. In other words, the two spots of the axis C1 and the axis C2 shown in FIG. 8 respectively serve as positioning parts of the case 20 and the bracket 40.

As detailed above, according to this embodiment, the case 20 includes a total of three first insertion holes H1 through which the fixing male screws FS fixing the case 20 to the bracket 40 are respectively inserted, and a total of three second insertion holes H2A, H2B, and H2C through which the fixing bolts FB fixing the bracket 40 to the electric brake device EB are respectively inserted. The bracket 40 has a total of three female screw members 48a into which the fixing male screws FS are respectively screwed, and the insertion holes HL of the collars 47a, 47b, and 47c through which the fixing bolts FB are respectively inserted. The total of three second insertion holes H2A, H2B, and H2C and the insertion holes HL of the total of three collars 47a, 47b, and 47c respectively include round holes that are arranged on the axis C1 with each other and position the case 20 with respect to the bracket 40.

Accordingly, during the assembly of the motor device 10, it is possible to arrange the second insertion hole H2A and the insertion hole HL of the collar 47a coaxially by simply using the positioning jig TL (see FIG. 7) composed of a round bar. Thus, it is possible to position the case 20 at the specified position of the bracket 40 with ease and high precision. Thus, it is possible to provide a motor device 10 and a manufacturing method thereof including a structure capable of simplifying the assembly process and reducing variations in motor characteristics.

Further, according to this embodiment, the motor device includes the rotating shaft 32 fixed at the rotation center of the rotor 31, the first bearing BR1 mounted to the case 20, and the second bearing BR2 mounted to the bracket 40. Two axial sides of the rotating shaft 32 are rotatably supported by the first bearing BR1 and the second bearing BR2.

Accordingly, it is possible to arrange the axis C1 and the axis C2 of the case 20 and the axis C1 and the axis C2 of the bracket 40 coaxially with each other, and thus it becomes possible to further position the case 20 at the specified position of the bracket 40 with ease and high precision.

Furthermore, according to this embodiment, a total of three first insertion holes H1 and a total of three second insertion holes H2A, H2B, and H2C respectively include long holes in which the fixing male screw FS and the fixing bolt FB are movable.

Accordingly, it is possible to absorb dimensional errors of the parts (e.g., the case 20 and the bracket 40) that form the connection portion of the motor device 10, and it becomes possible to easily assemble the motor device 10 and suppress occurrence of defective products.

Further, according to this embodiment, three first insertion holes H1 and three second insertion holes H2A, H2B, and H2C are provided, and the first insertion holes H1 and the second insertion holes H2A, H2B, and H2C are alternately arranged in the circumferential direction of the case 20 with the rotor 31 as the center.

Accordingly, it is possible to stably fix the case 20 with respect to the bracket 40 by three-point support, and it becomes possible to stably fix the bracket 40 (motor device 10) with respect to the electric brake device EB by three-point support.

Furthermore, according to this embodiment, the motor device 10 may be assembled according to the <butting process>, the <positioning process>, and the <screw fastening process>. Accordingly, it is not required to perform position adjustment between the stator assembly SA and the bracket assembly BA as in the related art. Thus, it becomes possible to assemble the motor device 10 more easily.

In addition, according to this embodiment, since it is possible to assemble the motor device 10 easily while suppressing occurrence of defective products of the motor device 10, it becomes possible to achieve energy saving in manufacturing. Accordingly, it becomes possible to achieve, in particular, Goal 7 (ensure access to affordable, reliable, sustainable and modern energy for all) and Goal 13 (take urgent action to combat climate change and its impacts) of the Sustainable Development Goals (SDGs) set forth by the United Nations.

The disclosure is not limited to the embodiments described above and may be variously modified without departing from the gist thereof. For example, in the above-described embodiment, the motor device 10 has been shown as a driving source of an electric brake device EB mounted to a vehicle such as an automobile. However, the disclosure is not limited thereto but may also be applied to a driving source of other vehicle-mounted devices (e.g., a driving source of electric power steering).

In addition, the material, shape, dimension, number, installation position, etc. of each component in the above embodiment may be configured in any manner and are not limited to the above embodiment as long as the disclosure can be achieved.

What is claimed is:

1. A motor device having a stator and a rotor rotated with respect to the stator, the motor device comprising:
a case in which the stator is fixed at a specified position;
a bracket that closes an opening of the case and is fixed to a driven target;
a board that is fixed at a specified position of the bracket and comprises a magnetic sensor detecting rotation of the rotor; and
a sensor magnet that is rotated together with the rotor and is opposed to the magnetic sensor, wherein
the case comprises:
a plurality of first screw holes through which first male screw members fixing the case to the bracket are respectively inserted; and
a plurality of second screw holes through which second male screw members fixing the bracket to the driven target are respectively inserted,
the bracket comprises:
a plurality of female screw members into which the first male screw members are respectively screwed; and
a plurality of insertion holes through which the second male screw members are respectively inserted, and
the plurality of second screw holes and the plurality of insertion holes respectively comprise round holes that are arranged coaxially with each other and position the case with respect to the bracket.

2. The motor device according to claim 1, further comprising:
a rotating shaft fixed at a rotation center of the rotor;
a first bearing mounted to the case; and
a second bearing mounted to the bracket, wherein
two axial sides of the rotating shaft are rotatably supported by the first bearing and the second bearing.

3. The motor device according to claim 1, wherein
the plurality of first screw holes and the plurality of second screw holes respectively comprise long holes in which the first male screw member and the second male screw member are movable.

4. The motor device according to claim 1, wherein the first screw holes and the second screw holes are respectively provided as three first screw holes and three second screw holes, and the first screw holes and the second screw holes are alternately arranged in a circumferential direction of the case with the rotor as a center.

5. A manufacturing method of a motor device having a stator and a rotor rotated with respect to the stator, the motor device comprising:
a case in which the stator is fixed at a specified position;
a bracket that closes an opening of the case and is fixed to a driven target;
a board that is fixed at a specified position of the bracket and comprises a magnetic sensor detecting rotation of the rotor; and
a sensor magnet that is rotated together with the rotor and is opposed to the magnetic sensor,
the manufacturing method comprising:
butting the opening of the case against the bracket and causing a case-side round hole provided at the case and a bracket-side round hole provided at the bracket to communicate with each other in an axial direction of the rotor;
inserting a positioning jig into the case-side round hole and the bracket-side round hole and arranging the case-side round hole and the bracket-side round hole coaxially with each other to position the case with respect to the bracket; and
with the case positioned with respect to the bracket, inserting a fixing male screw through a long hole provided at the case and screwing the fixing male screw into a fixing female screw provided at the bracket.
